(19) United States
(12) Patent Application Publication
(10) Pub. No.: US 2005/0062690 A1
(43) Pub. Date: Mar. 24, 2005

(54) Image displaying method and device for plasma display panel

(76) Inventor: Jae-Seok Jeong, Cheonan-si (KR)

Correspondence Address: McGuireWoods LLP, Suite 1800, 1750 Tysons Boulevard, McLean, VA, 22102-4215, US

(21) Appl. No.: 10/911,698

(22) Filed: Aug. 5, 2004

(30) Foreign Application Priority Data
Aug. 5, 2003 (KR) 2003-0054048

(51) Int. Cl. G09G 3/28

(52) U.S. Cl. 345/63

(57) ABSTRACT

A plasma display panel (PDP) image display and a method for driving a PDP. An input video signal is divided into subfields, luminance weights of the subfields are combined, and gray is displayed. The subfields include two consecutive subfield groups. The number of subfields included in the first subfield group is greater than a number of subfields included in the second subfield group. At least one subfield used to form low gray is included in the first subfield group, and a start time of the second subfield group is varied according to a load ratio of the input video signal.

### CROSS REFERENCE TO RELATED APPLICATION

This application is based on Korea Patent Application No. 2003-54048 filed on Aug. 5, 2003 in the Korean Intellectual Property Office, the content of which is incorporated herein by reference.

### BACKGROUND OF THE INVENTION

(a) Field of the Invention

The present invention relates to an image display method and device for a plasma display panel (PDP). More specifically, the present invention relates to a PDP image display method and device for reducing flicker and dynamic false contour (DFC) generated when inputting video signals and creating images.

(b) Description of the Related Art

A PDP is a display that includes a plurality of discharge cells arranged in a matrix pattern. PDPs create images from video signals by selectively causing the discharge cells to emit light.

Gray display, the ability to produce shades of gray, also allows the PDP to operate as a color display, because the various levels of gray display, when used in combination with colored phosphors, create the colors shown by the PDP. Typically, gray display PDPs implement dividing a single field into a plurality of subfields and performing time-division control on the subfields so as to allow the PDP to create a number of shades of gray.

Flicker is a phenomenon whose origin lies in the behavior and limitations of the human visual system. Typically, flicker is more frequently perceived by users viewing large or low-frequency displays.

When a PDP creates images based on a standardized type of video signal, such as a standard PAL video signal, the potential exists for a great deal of flicker. For example, when a PDP is driven at 50 Hz (the PAL standard frequency) by using a minimum increment arrangement or a minimum decrement arrangement, which are conventional arrangements of the subfields used to drive a PDP, a great deal of flicker is typically generated. These difficulties may also exist using other video standards.

Of the two general methods for controlling flicker, reducing screen size and controlling frequency, reducing screen size is usually undesirable. Therefore, a method for controlling the frequency is sometimes used to reduce flicker.

In a typical frequency control flicker reduction method, the subfields in a single frame are divided into two groups, G1 and G2, and the subfields of the groups except the least significant bit (LSB) subfield are established to have the same configuration, or luminance weights are similarly allocated to the subfields of the respective groups.

Several problems may occur with the typical frequency control method. For example, since the LSB and the LSB+1 are spread between the subfields of the two groups G1 and G2, the display-sustain period is typically short, and there is a time delay between the two groups, problems may occur in producing shades of low gray (e.g., 3, which comprises the LSB and LSB+1) and severe DFC may occur in a boundary of grays when an image sensed by the eyes moves.

Additionally, since the PDP consumes a great deal of power because of its driving features, an automatic power control (APC) for controlling the power consumption according to a load ratio (or an average signal level (ASL)) of a frame to be displayed is typically provided. The APC method controls the APC levels according to the load ratio of the input video data, and varies a number of sustain pulses for each APC level to control the power consumption to be below a predetermined level.

Following the APC method, the number of sustain pulses applied to each subfield according to the load ratio is varied. That is, the total number of sustain pulses applied to the respective groups G1 and G2 varies according to the load ratio, and since each subfield has a number of sustain pulses of as many as the number of luminance weights that the corresponding subfield has, the number of sustain pulses applied to each subfield also varies. Because the number of sustain pulses is varied, it is possible that while using APC, the durations and light emission centers of the two groups G1 and G2 may vary such that the two groups of subfields G1 and G2 lose periodicity and create flicker.

### SUMMARY OF THE INVENTION

One aspect of the invention relates to a method for driving a plasma display panel. The method comprises dividing one frame of image data into at least a first subfield group and a second consecutive subfield group. The first subfield group and the second consecutive subfield group are arranged such that a number of subfields included in the first subfield group is greater than a number of subfields included in the second subfield group. One or more subfields used to form low gray are included in the first subfield group. The method also comprises timing the first subfield group and the second consecutive subfield group such that a start time of the second subfield group changes according to a load ratio of an input video signal.

Another aspect of the invention relates to a method for driving a plasma display panel. The method comprises generating subfield data and address data that correspond to an input video signal, a control signal, and a start point of each subfield. The method also comprises applying the generated subfield data, the address data, and the control signal to a plasma display panel. The subfield data represents at least a first subfield group and a second consecutive subfield group such that the number of subfields in the first subfield group is greater than the number of subfields in the second subfield group, and such that one or more subfields used to form low gray is included in the first subfield group. The control signal is for a subfield arrangement that includes at least the first subfield group and the second consecutive subfield group. The subfield arrangement is based on a number of sustain pulses determined by a load ratio of the input video signal.

A further aspect of the invention relates to a controller for a plasma display panel adapted to produce a plasma display panel control signal representing a number of image display subfields. The subfields are configured such that they include at least a first subfield group and a second consecutive subfield group. The number of subfields included in the first subfield group is greater than the number of subfields included in the second consecutive subfield group. At least one subfield used to form low gray is included in the first subfield group. Additionally, the light emission centers between the first subfield group and the second consecutive subfield group in a single frame are periodic irrespective of variation in a load ratio of an input video signal.

Another further aspect of the invention relates to a plasma display panel. The plasma display panel comprises a video signal processor adapted to digitize the input video signal to generate digital video data. The plasma display panel also comprises a vertical frequency detector adapted to detect the digital video data output by the video signal processor to detect whether the input video data is an NTSC signal or a PAL signal, to establish a corresponding result as a data switch value, and to output the data switch value together with the digital video data. A memory controller of the plasma display panel is adapted to receive the digital video data and the data switch value generated by the vertical frequency detector, generate subfield data and address data corresponding to one of the NTSC and PAL video signals according to the data switch value, and apply the subfield data and the address data to the PDP. The memory controller is adapted to generate the subfield data such that the subfield data correspond to subfields including two consecutive subfield groups, with a number of subfields included in a first subfield group being greater than a number of subfields included in a second subfield group, and such that at least one subfield used for forming low gray is included in the first subfield group. An automatic power control unit of the plasma display panel is adapted to detect a load ratio of the digital video data output by the vertical frequency detector, calculate an automatic power control level according to the detected load ratio, produce a number of sustain pulses corresponding to the calculated automatic power control level, and output the number of sustain pulses. A subfield variable range determination unit of the plasma display panel is adapted to determine a variable range of each subfield according to the load ratio output by the automatic power control unit and determine a start point for each subfield within the determined variable range. A sustain and scan pulse driver of the plasma display panel is adapted to receive the number of sustain pulses, an address pulse width of each subfield, a start position of each subfield, and a data switch value output by the subfield variable range determination unit, determine whether the plasma display panel is in an NTSC video signal mode or a PAL video signal mode according to the data switch value to generate a subfield arrangement configuration, generate a control signal based on the generated subfield arrangement, and apply the control signal to the plasma display panel.

### BRIEF DESCRIPTION OF THE DRAWINGS

The accompanying drawings, which are incorporated in and constitute a part of the specification, illustrate embodiments of the invention, and, together with the description, serve to explain the principles of the invention.

FIG. 1 is a diagram illustrating a subfield structure according to a first preferred embodiment of the present invention.

FIG. 2 is a diagram illustrating an example of partial realization of low gray by using the arrangement according to the first embodiment of the present invention.

FIG. 3 is a conceptual diagram of a DFC generated when an image moves when the adjacent grays are 4 and 3 in the subfield structure according to the first embodiment of the present invention.

FIGS. 4(a) and 4(b) are diagrams illustrating positions of the subfields and central positions of light emission for each APC in the subfield structure shown in FIG. 2, FIG. 4(a) illustrating a case in which the APC is at a minimum, and FIG. 4(b) illustrating a case in which the APC is at a maximum.

FIGS. 5(a) through 5(c) are diagrams illustrating a subfield structure according to a second embodiment of the present invention, FIG. 5(a) illustrating a case in which the APC is at a minimum, FIG. 5(b) illustrating a case in which the APC is at an intermediate value, and FIG. 5(c) illustrating a case in which the APC is at a maximum.

FIGS. 6(a) and 6(b) are diagrams illustrating positions of the subfields and central positions of light emission for each APC in the subfield structure shown in FIG. 5, FIG. 6(a) illustrating a case in which the APC is at a minimum, and FIG. 6(b) illustrating a case in which the APC is at a maximum.

FIGS. 7(a) and 7(b) are diagrams illustrating the relationship between the APC level and the subfield interval, FIG. 7(a) illustrating a subfield structure according to the first embodiment, and FIG. 7(b) illustrating a PDP subfield structure according to the second embodiment.

FIG. 8 is a block diagram of a PDP image display according to an embodiment of the present invention.

### DETAILED DESCRIPTION

In the following detailed description, only certain exemplary embodiments of the invention has been shown and described, simply by way of illustration. As will be realized, embodiments of the invention are capable of modification in various respects, all without departing from the invention. Accordingly, the drawings and description are to be regarded as illustrative in nature, rather than restrictive.

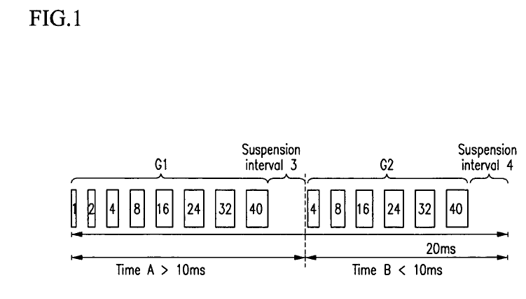

FIG. 1 is a schematic diagram illustrating a subfield structure in PDP driving methods according to a one embodiment of the present invention.

As shown in FIG. 1, a frame according to a preferred embodiment of the present invention includes two individual subfield groups G1 and G2, and two suspension intervals 3 and 4 respectively provided to the end of the groups G1 and G2.

The first group G1 has eight subfields, and respective luminance weights of the subfields are established to be 1, 2, 4, 8, 16, 24, 32, and 40 from the lowest subfield, and they can be varied according to usage format by a skilled person. The second group G2 has six subfields, and respective luminance weights thereof are established to be 4, 8, 16, 24, 32, and 40 from the lowest subfield, and they can be varied according to the luminance weights of the first group G1 by a skilled person. As can be seen from FIG. 1, the subfield arrangement of the first group G1 is formed by adding the subfields of the LSB and the next least significant bit (LSB+1), which have luminance weights of 1 and 2, to the subfield arrangement of the second group G2 so that the subfields of the LSB and the (LSB+1) may be closely provided to the subfield arrangement of the second group G2.

In this instance, the first group G1 starts at a start position of the frame, that is, 0 ms, and the total interval (indicated in FIG. 1 as Time A), including the suspension interval 3 during which the APC does not operate because of the minimum load ratio, is established to be greater than 10 ms. Therefore, the total interval (indicated in FIG. 1 as Time B) of the second group G2, including the suspension interval 4, is established to be less than 10 ms to thus satisfy a condition of “Time A>Time B.”

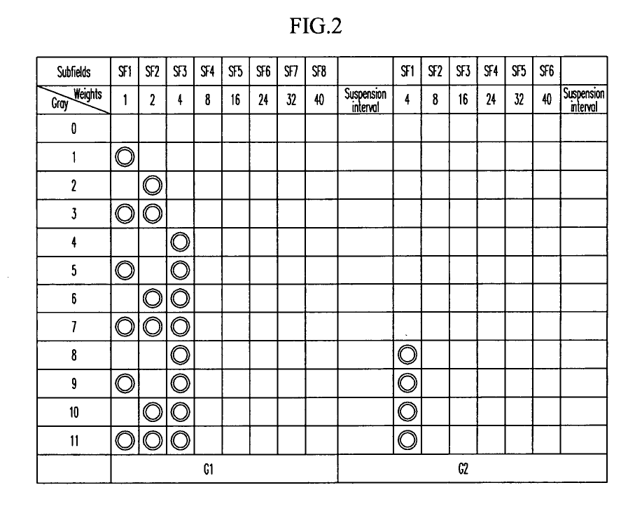

FIG. 2 shows an exemplified partial realization of low gray by using the arrangement according to the first preferred embodiment of the present invention.

As shown in FIG. 2, in the case of displaying low gray, for example, shades of low gray ranging from 1 through 11, by using the subfield arrangement according to this embodiment of the invention, the time difference between the sub fields corresponding to the luminance weights of 1 and 2, that is, the LSB and the (LSB+1), is minimal and far less than in prior art methods, such that it can be ignored.

For example, as shown in the table illustrated in FIG. 2, the lowest subfields SF1 and SF2 of the first group G1 are turned on in the case of low gray shade 3. In this example, because both of the turned-on subfields SF1 and SF2 are within the first group G1, the time difference between the subfields is very much less.

Accordingly, since the time difference between the subfields corresponding to the LSB and the (LSB+1) used for forming low gray is very much less when the subfields corresponding to the LSB and the (LSB+1) are arranged close to one another at the start position of the first group G1, the DFC generated on the boundary of grays may be greatly reduced in the case of a moving image perceived by the eyes.

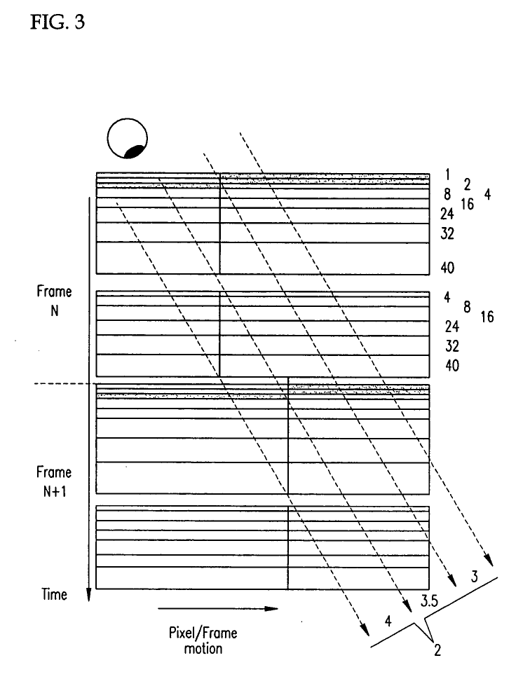

FIG. 3 is concept diagram of a DFC generated when an image moves when the adjacent grays are 4 and 3 in the subfield structure according to the first embodiment of the present invention. As shown in FIG. 3, when the adjacent grays are 4 and 3, respectively, using the subfield structure according to the first preferred embodiment, there are two points at which DFC occurs when an image moves, and the difference values between the highest gray 4 from among the original grays and the distorted gray are 2 and 0.5, respectively, depending on generation points. From this, it is known that the number of DFCs is reduced by three compared to the case of the conventional PDP subfield structure, and the difference value between the distorted gray value and the original gray is reduced to ¼. Accordingly, the present invention can greatly reduce DFC in the subfield, as compared with the conventional PDP.

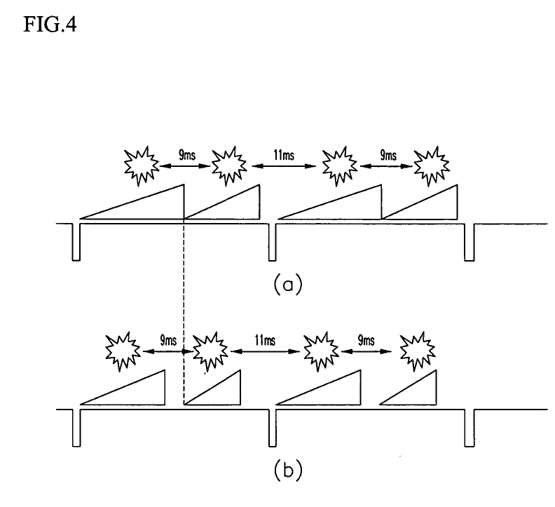

As noted above, APC with a conventional sub-field arrangement can cause problems in the periodicity of the two sub-field groups G1 and G2, which results in increased flicker. The subfield positions and light emission centers when APC is performed using the subfield structure according to this embodiment of the present invention will be described with reference to FIGS. 4(a) and 4(b), which illustrate positions of the subfields and central positions of light emission for each APC in the subfield structure shown in FIG. 1. Of the two figures, FIG. 4(a) illustrates a case in which the APC is the minimum, and FIG. 4(b) illustrates a case in which the APC is the maximum.

As shown in FIGS. 4(a) and 4(b), a gap between the position of the light emission center of the first group G1 and the position of the light emission center of the second group G2 within the identical frame is exemplified as 9 ms when the APC is the minimum, and a gap between the position of the light emission center of the second group G2 and the position of the light emission center of the first group G1 of the next frame is exemplified as 11 ms, which is slightly greater than the above-noted interval of 9 ms.

As shown in FIG. 4(b), the gap between the positions of the light emission centers of the first group G1 and the second group G2 when the APC operates or becomes the maximum compared to the case when the APC is the minimum is matched with the case when the APC shown in FIG. 4(a) is the minimum, and the gap between the positions of the light emission centers of the second group G2 and the first group G1 of the next frame is matched with the case when the APC is the minimum as shown in FIG. 4(a).

As described above, when the APC is operated at or becomes the maximum compared to the case when the APC is the minimum, the respective subfield intervals of the first group G1 and the second group G2 are reduced. When the suspension intervals 3 and 4 are increased, the start point of the second group G2 is the same, the gap between the positions of the light emission centers of the first and second groups G1 and G2 within the same frame does not change, and the gap between the positions of the light emission centers of the second group G2 and the next frame's first group G1 does not change. Accordingly, the gap between the positions of the respective light emission centers is the same as the case in which the APC is at a minimum, irrespective of APC levels.

Therefore, since the start position of the subfield is fixed without relation to any variation in the APC levels, that is, since the start point of the second group G2 is fixed irrespective of the APC levels, the centers of the light emission of the groups G1 and G2 are not periodic, and thus, may cause flicker.

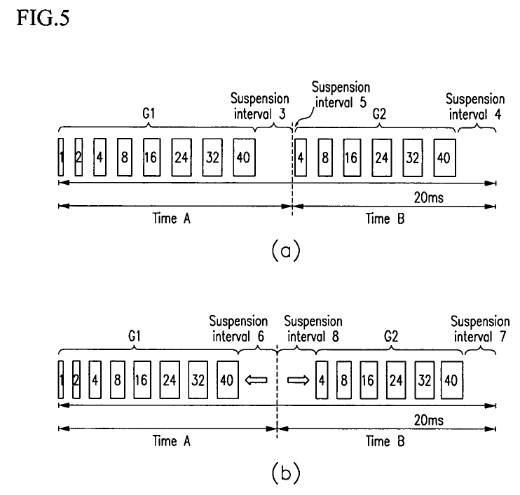

To address this issue, a subfield structure according to a second embodiment of the present invention will be described with respect to FIGS. 5(a) and 5(b). FIG. 5(a) illustrates a case in which the APC is the minimum, and FIG. 5(b) illustrates a case when the APC is the maximum.

As shown in FIG. 5(a), the subfield structure according to the second embodiment corresponds to that of the first embodiment shown in FIG. 1 in the case of the minimum APC. However, one difference between the subfield structures shown in FIGS. 1(a) and 1(b) and FIGS. 5(a) and 5(b) are the suspension intervals 3 and 5 of the second embodiment. Since the suspension interval 5 provided at the start point of the second group G2 has the minimum load ratio and it is rarely displayed with the maximum sustain pulse, in the second embodiment, the case of the minimum APC is ignored. More particularly, the occupation time of the second group G2 includes the suspension interval 5 as well as the suspension interval 4.

The suspension interval 5 is very short when the APC is the minimum, but as shown in FIG. 5(b), the suspension interval 5 is very long when the APC is at a maximum and the minimum load ratio is displayed with the minimum sustain pulse. This differs from the subfield structure according to the first embodiment described with reference to FIG. 1. As a result, the start point of the second group G2 is delayed compared to the start point when the APC is not operating. In this instance, the suspension interval 7 is fixed so that it is the same or slightly greater duration than the suspension interval 4 when the APC is not operating, and since the suspension intervals 6 and 8 increase with inclusion of the increments of the suspension interval 7, they become greater than the suspension intervals 3 and 5 when the APC does not operate.

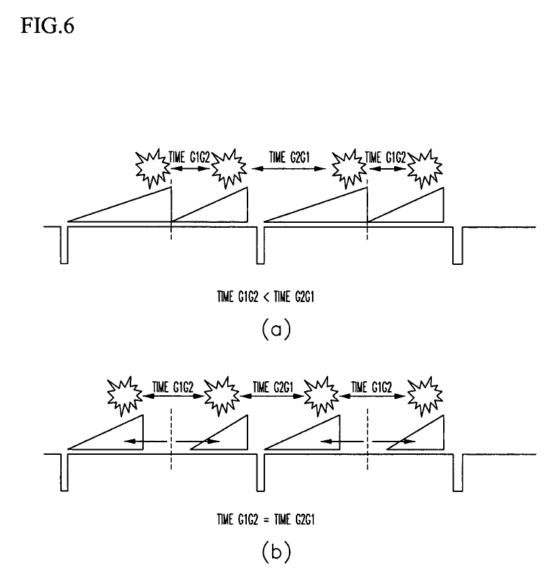

FIGS. 6(a) and 6(b) are schematic diagrams illustrating the positions of the subfields and the central positions of light emission for each APC in the subfield structure shown in FIG. 5, FIG. 6(a) illustrates a case when the APC is at a minimum, and FIG. 6(b) showing a case when the APC is at a maximum.

As shown in FIGS. 6(a) and 6(b), the subfield intervals of the first and second groups G1 and G2 are reduced, and the suspension intervals thereof are increased when the APC is at a maximum, as compared to the case when the APC is at a minimum.

In this case, since the start point of the second group G2 is changed so as to be more distant from the first group G1 as the APL level increases compared to the case in which the APC level is low, the gap (Time G1G2) between the positions of the light emission centers of the first and second groups G1 and G2 within the same frame is longer compared with the case in which the APC is at a low level, and the gap (Time G2G1) between the positions of the light emission center of the second group G2 and the light emission center of the first group G1 of the next frame is shorter compared with the case in which the APC is at a low level, and as a result, the time gaps (Time G1G2 and Time G2G1) between the respective subfield groups G1 and G2 are identical.

As described, the gaps (Time G1G2 and Time G2G1) between the positions of the light emission centers between the subfield groups G1 and G2 have periodicity because the subfield arrangement allows the positions of the light emission centers of the respective subfield groups G1 and G2 to vary within the same frame or between other frames, thereby causing the time gaps (Time G1G2 and Time G2G1) of the respective subfield groups G1 and G2 to be the same. Because the time gaps between subfield groups are the same, flicker is reduced.

More generally, the start point of the second group G2 may be varied within a range in which the gap between the positions of the light emission centers of the first and second groups G1 and G2 are the same or similar to each other. As those of skill in the art will appreciate, perfect identity is not required in order to reduce flicker.

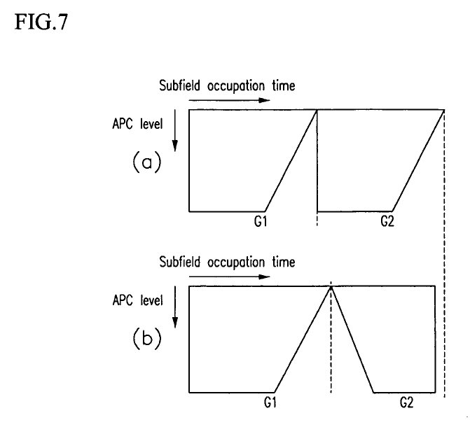

FIGS. 7(a) and 7(b) are schematic diagrams illustrating the relationship between the APC level and the subfield interval (an occupation time). FIG. 7(a) illustrates the case in which the subfield structure according to the first embodiment is used, and FIG. 7(b) illustrates the case in which the subfield structure according to the second embodiment is used.

As shown in FIGS. 7(a) and 7(b), the gap of the subfield interval following the APC level in the subfield structure according to the second preferred embodiment is selected such that the two subfield groups G1 and G2 have periodicity. This is done by varying the start point of the second group G2, as compared to the subfield interval following the APC level of the subfield structure, according to the first embodiment, thereby reducing flicker.

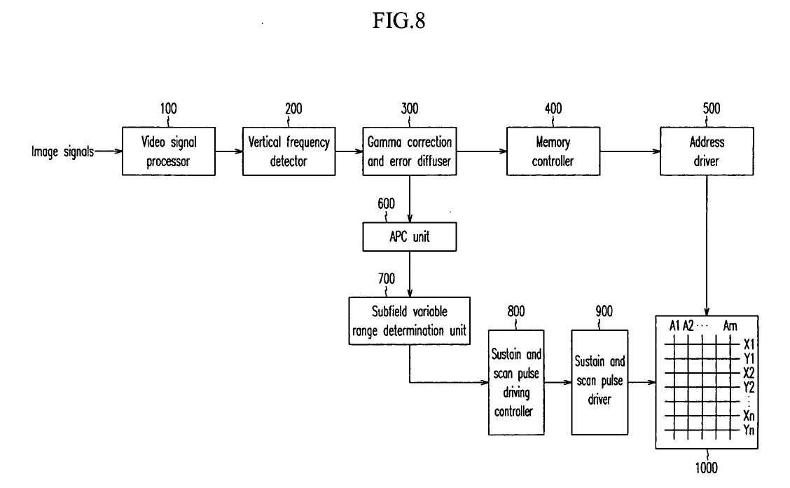

FIG. 8 is a block diagram of a PDP image display according to an embodiment of the present invention. As shown in FIG. 8, the PDP image display comprises a video signal processor 100, a vertical frequency detector 200, a gamma correction and error diffuser 300, a memory controller 400, an address driver 500, an APC unit 600, a subfield variable range determination unit 700, a sustain and scan pulse driving controller 800, and a sustain and scan pulse driver 900.

The video signal processor 100 digitalizes external video signals to generate digital video signals.

The vertical frequency detector 200 analyzes the digital video signals output by the video signal processor 100 to determine whether the input video data are 60 Hz NTSC signals or 50 Hz PAL signals, establishes a corresponding result as a data switch value, and outputs the data switch value together with the digital video signals.

The gamma correction and error diffuser 300 receives the digital video signals output by the vertical frequency detector 200, corrects the gamma value according to the features of the PDP, performs spreading on display errors to adjacent pixels, and outputs results. In this example, the data switch value that indicates whether the video signals output by the vertical frequency detector 200 are 50 Hz or 60 Hz video signals is output to the memory controller 400 and the APC unit 600.

The memory controller 400 receives the digital video data and the data switch value output by the gamma correction and error diffuser 300, and generates subfield data corresponding to the digital video data input by generating subfield data appropriate for 50 Hz or 60 Hz video signals, according to the data switch value. However, it should be understood that other frequencies may be used.

In this embodiment of the invention, when the data switch value indicates 60 Hz video signals, subfield data corresponding to the digital video data are generated such that there is a single subfield group.

However, when the data switch value indicates 50 Hz video signals, the subfields are divided into two subfield groups, G1 and G2, as shown in FIGS. 1 and 5(a), and subfield data is generated so that the first group G1 has eight subfields and the second group G2 has six subfields. The subfield data are input to/output from a memory, and output to the address driver 500.

The address driver 500 generates address data corresponding to the subfield data output by the memory controller 400, and applies the address data to address electrodes A1 through Am of the PDP 1000.

The APC unit 600 uses the video data output by the gamma correction and error diffuser 300 to detect a load ratio, calculates an APC level according to the detected load ratio, produces a number of sustain pulses corresponding to the calculated APC level, and outputs the number.

The subfield variable range determination unit 700 determines a variable range of each subfield according to the load ratio output by the APC unit 800, and determines a start point of each subfield within the determined variable range.

The sustain and scan pulse driving controller 800 receives the number of sustain pulses, the start point of each subfield, and the data switch value output by the subfield variable range determination unit 700, classifies as the 50 Hz video signal case and the 60 Hz video signal case, generates each subfield arrangement configuration, and outputs the same to the sustain and scan pulse driver 900.

The sustain and scan pulse driver 900 sustains and scans pulses based on the subfield arrangement configuration output by the sustain and scan pulse driving controller 800, and applies them to the scan electrodes X1 through Xn and sustain electrodes Y1 through Yn of the PDP 1000.

In embodiments according to the present invention, the DFC in the low gray region is greatly reduced by arranging the subfields of the LSB and LSB+1 which are used for forming low gray closely together, within the first group G1 to reduce the time difference between the subfields. Additionally, the flicker phenomenon is substantially reduced by maintaining the periodicity of the light emission centers between the subfield groups.

While this invention has been described in connection with certain embodiments, it is to be understood that the invention is not limited to the disclosed embodiments, but, on the contrary, is intended to cover various modifications and equivalent arrangements included within the spirit and scope of the appended claims.

1. A method for driving a plasma display panel, comprising:
dividing one frame of image data into at least a first subfield group and a second consecutive subfield group, the first subfield group and the second consecutive subfield group being arranged such that a number of subfields included in the first subfield group is greater than a number of subfields included in the second subfield group;
including one or more subfields used to form low gray in the first subfield group; and
timing the first subfield group and the second consecutive subfield group such that a start time of the second subfield group changes according to a load ratio of an input video signal.

2. The method of claim 1, wherein luminance weights of the one or more subfields used to form low gray correspond to the least significant bit and the next least significant bit from among the respective luminance weights of the subfields.

3. The method of claim 2, wherein the one or more subfields used to form low gray are positioned at a beginning of the first subfield group.

4. The method of claim 1, wherein the start time of the second subfield group is selected such that if the load ratio is larger, the start time of the second subfield group is later.

5. The method of claim 1, wherein a suspension interval is provided at a beginning of the second subfield group, and
the beginning of the second subfield group changes according to the length of the suspension interval, depending on the load ratio.

6. The method of claim 5, wherein the length of the suspension interval increases to delay the beginning of the second subfield group when the load ratio increases.

7. A method for driving a plasma display panel, comprising:
generating
subfield data and address data that correspond to an input video signal, the subfield data representing at least a first subfield group and a second consecutive subfield group such that a number of subfields in the first subfield group is greater than a number of subfields in the second subfield group, and such that one or more subfields used to form low gray is included in the first subfield group;
a control signal for a subfield arrangement that includes at least the first subfield group and the second consecutive subfield group, the subfield arrangement being based on a number of sustain pulses determined by a load ratio of the input video signal; and
a start point of each subfield; and
applying the generated subfield data, the address data, and the control signal to the plasma display panel.

8. The method of claim 7, wherein the one or more subfields used to form low gray comprise a least significant bit subfield and a next least significant bit subfield.

9. The method of claim 8, wherein the one or more subfields used to form low gray are positioned at a beginning of the first subfield group.

10. The method of claim 9, wherein the start time of the second subfield group is selected such that if the load ratio is larger, the start time of the second subfield group is later.

11. The method of claim 7, wherein a suspension interval is provided at a beginning of the second subfield group, and the beginning of the second subfield group is varied according to the length of the suspension interval, depending on the load ratio.

12. The method of claim 11, wherein the length of the suspension interval increases to delay the beginning of the second subfield group when the load ratio increases.

13. A controller for a plasma display panel, the controller adapted to produce a plasma display panel control signal representing a number of image display subfields, the subfields being configured such that:
the subfields include at least a first subfield group and a second consecutive subfield group;
a number of subfields included in the first subfield group is greater than a number of subfields included in the second consecutive subfield group;
at least one subfield used to form low gray is included in the first subfield group; and
light emission centers between the first subfield group and the second consecutive subfield group in a single frame are periodic irrespective of variation in a load ratio of an input video signal.

14. The controller of claim 13, wherein the light emission centers are periodic in the span between the first subfield group and the second subfield group formed within the single frame and are periodic in the span between the second subfield group and a subsequent first subfield group formed in a different frame.

15. The controller of claim 13, wherein the light emission centers have the same periodicity between the first subfield group and the second subfield group formed within the single frame and between the second subfield group and the subsequent first subfield group.

16. A plasma display panel, comprising:
a video signal processor adapted to digitize the input video signal to generate digital video data;
a vertical frequency detector adapted to detect the digital video data output by the video signal processor to detect whether the input video data is an NTSC signal or a PAL signal, to establish a corresponding result as a data switch value, and to output the data switch value together with the digital video data;
a memory controller adapted to:
receive the digital video data and the data switch value generated by the vertical frequency detector,
generate subfield data and address data corresponding to one of the NTSC and PAL video signals according to the data switch value, and
apply the subfield data and the address data to the plasma display panel, the memory controller being adapted to generate the subfield data such that the subfield data correspond to subfields including two consecutive subfield groups, with a number of subfields included in a first subfield group being greater than a number of subfields included in a second subfield group, and such that at least one subfield used for forming low gray is included in the first subfield group; an automatic power control unit adapted to
detect a load ratio of the digital video data output by the vertical frequency detector,
calculate an automatic power control level according to the detected load ratio,
produce a number of sustain pulses corresponding to the calculated automatic power control level, and
output the number of sustain pulses;
a subfield variable range determination unit adapted to determine a variable range of each subfield according to the load ratio output by the APC unit, and
determine a start point for each subfield within the determined variable range; and
a sustain and scan pulse driver adapted to
receive the number of sustain pulses, an address pulse width of each subfield, a start position of each subfield, and a data switch value output by the subfield variable range determination unit,
determine whether the plasma display panel is in an NTSC video signal mode or a PAL video signal mode according to the data switch value to generate a subfield arrangement configuration,
generate a control signal based on the generated subfield arrangement, and
apply the control signal to the plasma display panel.

17. The plasma display panel of claim 16, wherein the subfield variable range determination unit establishes the start time of the second subfield group to be later if the load ratio is higher than the start time of the second subfield group if the load ratio is lower.

18. A computer-readable recording medium having stored thereon instructions in computer-readable form that, when executed, enable the computer to execute a method for controlling a plasma display panel comprising:
determining whether an input video signal is a PAL signal;
if the input video signal is found to be a PAL signal, generating subfield data and address data corresponding to the input video signal, and generating a control signal for a subfield arrangement configuration based on a number of sustain pulses following a load ratio of the input video signal and a start position of each subfield, such that
the subfield data correspond to subfields including two consecutive subfield groups,
a number of subfields included in a first subfield group is greater than a number of subfields included in a second subfield group, and
at least one subfield used to form low gray is included in the first subfield group; and
applying the generated subfield data, the address data, and the control signal for the subfield arrangement configuration to the plasma display panel.
